(19) United States
(12) Patent Application Publication
(10) Pub. No.: US 2009/0214716 A1
(43) Pub. Date: Aug. 27, 2009

(54) SYSTEM AND METHOD FOR CONTROL OF CAFFEINE PREPARATION AND USE

(76) Inventor: Niva Shapira, Tel Aviv (IL)

Correspondence Address: Naomi Assia Law Offices;C/O Landon IP Inc., Suite 450, 1700 Diagonal Road, Alexandria, VA, 22314, US

(21) Appl. No.: 12/159,622

(22) PCT Filed: Dec. 31, 2006
(86) PCT No.: PCT/IL06/01512

§ 371 Date: Nov. 28, 2008

Related U.S. Application Data
(60) Provisional application No. 60/754,305, filed on Dec. 29, 2005.

(51) Int. Cl. A23L 1/48

(52) U.S. Cl. 426/87; 426/392

(57) ABSTRACT

A caffeine management system, comprising caffeine products, including information about at least one of natural and pre-determined caffeine content, preparation means thereof, at least one of labeling existing and predetermined contents in at least one of absolute and relative caffeine consumption-units, as per acceptable servings/packaging and at least one of available devices and newly-designed devices and packages.

### FIELD OF THE INVENTION

The present invention generally relates to caffeine products, and particularly to those products especially prepared to have a pre-determined caffeine-content for the purpose of caffeine control by consumers.

### BACKGROUND OF THE INVENTION

As over-consumption of caffeine may be unwanted and even a risk for certain conditions, i.e., abnormal blood pressure, heartburn, pregnancy, etc, acceptable daily caffeine consumption was defined by health authorities, such as the American Heart Association and the American Dietetic Association to be 300 mg/day. Another aspect of over-consumption may be that it is habit forming. People may get used to an over-caffeine state, and have withdrawal syndrome symptoms, such as headaches, temporal reduced blood pressure, changes in blood clotting, etc.

However, as caffeine consumption has been found to be positively associated with certain health benefits, e.g., reducing risk of mental decline, diabetes and certain performance benefits, such as increased cognitive concentration and effective sport performance etc., one would preferably want to control daily caffeine intake for the sake of the advantages and not go beyond adequate intake. Moreover recent research showed that dividing the caffeine for small portions along the day increase its effectiveness and reduce its sleep interference.

Hitherto, caffeine concentrations and contents are imprecise, non-standard, individually non-normalized and frequently unknown entirely. These vary with botanical sources, extraction and preparation processes, food recipes, etc. Labeling of caffeine information may be meaningless, unless one translates it into terms of caffeine consumption habits. Also people differ in their sensitivities, requirements, schedules and caffeine use. Thus applicable caffeine information available in an understandable way is important for individual control.

Chemistry and Botanical roles: Caffeine, also known as trimethylxanthine, coffeine, theine, mateine, guaranine, methyltheobromine and 1,3,7-trimethylxanthine is a xanthine alkaloid found naturally in such foods as coffee beans, tea, kola nuts, Yerba mate, guarana berries, and cacao beans in small amounts. For plants, caffeine is a natural pesticide and paralyzes and kills insects that attempt to feed on it.

Caffeine Effect, Metabolism, Pharmacokinetics and Toxicology

Caffeine is thought to act on the brain, but in fact, acts on most cells of the body. All cells have adenosine receptors, which are blocked by caffeine, thereby blocking a pathway that leads to the breakdown of cyclic adenosine monophosphate, (CAMP). Adenosine, when bound to receptors of nerve cells, slows down nerve cell activity. This happens, among other times, during sleep. The caffeine molecule, being similar to adenosine, binds to the same receptors, but does not cause the cells to slow down; instead, caffeine blocks the receptors and thereby the adenosine action.

The resulting increased nerve activity causes the release of the hormone epinephrine (adrenaline), which in turn leads to several effects, such as higher heart rate, increased blood pressure, increased blood flow to muscles, decreased blood flow to the skin and inner organs, and release of glucose by the liver. In addition, caffeine, similar to amphetamines, increases the levels of the neurotransmitter dopamine in the brain.

Caffeine is quickly and completely removed from the brain, and, unlike other central nervous system (CNS) stimulants. or alcohol, its effects are short-lived. As caffeine does not negatively affect concentration or higher mental functions, caffeinated drinks are often consumed in the course of work.

Time to impact: The caffeine effect begins about 15 minutes to several hours after consumption.

Beyond the Brain: Caffeine Inhibits Platelet Aggregation

Caffeine alters adenosine receptors and their function and alters human platelets. Chronic caffeine consumption results in sensitization and/or up-regulation of endogenous adenosine receptors in normal subjects. Chronic caffeine consumption may lead to a reduction in platelet aggregability as a result of non-regulation of the A_{2A} receptors that are located on the platelet surface (see references below, Varani et al., 1999).

### Dietary Caffeine Sources and Contents

The coffee bean is the main dietary source of caffeine, but varieties of coffee beans vary highly in caffeine content. Caffeine content varies substantially between Arabica and Robusta species and to a lesser degree between varieties of each species. In U.S. Pat. No. 5,436,395, assigned to Kraft Foods by Sondahl, et al, “induction and selection of somaclonal variation in coffee,” a process is disclosed for generating and selecting someclonal variations in coffee—applies tissue culture methodology for variety development and breeding of selected superior genotypes for commercial production.

Sondahl, et al, teach that there are two commercial coffee species, Coffea arabica L. (arabica type coffee) and Coffea canephora p. ex Fr. (canephora or Robusta type coffee). Coffee is a tropical and perennial tree which produces coffee berries. The coffee beverage is produced by percolating hot water through roasted coffee seeds. Arabica coffee provides a superior coffee beverage and it is typical of the highland growing regions while Robusta coffee produces a lower quality coffee and is grown in lowland regions.

A breeding cycle for coffee plants takes four years, i.e., seeds to a flowering plant and back to seeds. Selections for yield are usually made from 6-8 year old coffee plants. Several cycles of crossings and selections are required until one finds superior genotypes. In order to assure fidelity through seed propagation, six cycles of selfing are required. Considering one cycle for hybridization and selection and six cycles for seed homozygosity, a normal coffee breeding program requires 28 years. Cell culture techniques, such as somatic embryogenesis, clonal propagation, and protoplast regeneration provide opportunities to shorten the time requirement for coffee improvement.

Tea is another common source of caffeine, as consumed in many cultures. Tea contains somewhat less caffeine per serving than coffee, usually about half as much, depending on the strength of the brew. Though certain types of tea, such as Lapsang sou chong smoked teas and oolong, contain less caffeine.

Soft drinks: Caffeine is also common in soft drinks, e.g., cola. Such drinks typically contain about 25-50 mg caffeine/serving. Some “energy drinks.” e.g., Red Bull contain 80 mg, while others offer considerably more caffeine per serving, from 100 mg to 400 mg.

Other caffeine sources: Mateine and guaranine are other names for caffeine. The names come from yerba mate and guarana respectively, caffeine-containing plants used for tea and other things.

Average Caffeine Contents of Foods & Drinks

Caffeine content in 8 ounce coffee cups are on average 100 mg. For brewed coffee caffeine content in an 8 ounce cup is 135 mg; General Foods international coffee: orange—102, Vienna—90 mg; Instant−95 mg; Mocha coffees and French vanilla range between 45-65 mg; Chocolate cafes: 25-30 mg. For other drinks: Caffeinated teas (8 ounces) and caffeine-soft drinks (12 ounces) range around 50 mg/serving (According to CSPINET.Org Cafcharts).

### Caffeine Consumption: Habits, Reasons and Risks

Daily caffeine consumption: The average American consumes about one or two cups of coffee comprising 230 milligrams (mg) of caffeine a day, about the same amount as in two 12-ounce or 2.5 cups of brewed coffee. For children, the major source of caffeine is carbonated beverages and tea. The average American child consumes about 21 mg of caffeine a day. But this may change as the number and popularity of highly caffeinated, or “supercaffeinated,” beverages increases (www.mayoclinic.com).

Why do we need morning coffee? Overnight one accumulates adenosine tripyhosphate (ADP), which reduces mood and vigilance. The caffeine in coffee is the ‘instantly’ available antagonist ADP, which can be used as a ‘starter’ of the brain from ADP inhibition. The molecule adenosine triphosphate (ATP) is called the fuel of life. It supplies energy to cells through its conversion to ADP, along with B1 B2, B3 and pantothenic acid. ADP is converted to ATP for the storage of energy.

Overnight Caffeine-Withdrawal:

‘Withdrawal hypothesis’ suggests that caffeine mostly benefits habitual consumers and/or consumers under ‘withdrawal effect,’ who restore their capacity to normal, not necessarily enhancing performance beyond its effect on non-consumers or on those after long term withdrawal. Here, according to withdrawal hypothesis, night avoidance can be perceived as ‘acute coffee withdrawal,’ which explains the craving for coffee in the morning (see below Rogers, et al., 2005).

Risk of morning caffeine overdosing: As people like to feel the caffeine instantly, they do not like to wait for the caffeine effect. Thus, they flood themselves with a few morning coffee mugfulls, which is considered ‘overdoing.’

It now seems that most of the population is using caffeine the wrong way by drinking a few mugs of coffee or tea in the morning, or three cups from their ‘Coffee to go.’ As a result, caffeine levels in the brain will be falling as the day goes on, when they need it the most (see below Wyatt, et al., 2004).

Risk of Caffeine tolerance: Continued consumption of caffeine can lead to tolerance. Upon withdrawal, the body becomes oversensitive to adenosine, causing the blood pressure to drop dramatically, leading to headache and other symptoms. Any accumulated sleep debt will be fully felt on withdrawal as well.

Risk of Caffeine intoxication: Too much caffeine can lead to caffeine intoxication. The symptoms of this disorder are restlessness, nervousness, excitement, insomnia, flushed face, diuresis, gastrointestinal complaints, even hallucinations. These can occur in some people after as little as 250 mg per day. More than 1,000 mg per day may result in muscle twitching, rambling flow of thought and speech, cardiac arrhythmia or tachycardia and psychomotor agitation. Caffeine intoxication can lead to symptoms similar to panic disorder and generalized anxiety disorder. Women, children and elderlies are much more sensitive to caffeine as they have reduced enzymatic capacity for its catabolism.

Risk of Abuse and overdose: Caffeine, in its many forms, has been used for its stimulating effects. In modern times the substance can be produced in much higher quantities, and has found its way into many products. Purer forms, such as those in caffeine pills, are easily available, sometimes used by college students and shift workers, to provide an entire night without sleep. Caffeine pills, such as No-Doz, have been under media fire for recent and past deaths of students. Caffeine pills are restricted to 200 mg or less in the U.S.

Risk of Sleep deficiency: Caffeine may be used to stay alert when one is under the influence of alcohol or in severe sleep debt. The problem is that users think they are more alert than they really are. Activities, such as driving, may be dangerous in such cases. Even aside from such activities, caffeine does not make up for the poor mental performance caused by lack of sleep. The word caffeinism has been coined to mean addiction to, or debilitating dependence on, caffeine.

Risk During Pregnancy: Caffeine may cause miscarriage or may slow the growth of a developing fetus when given in doses greater than 300 mg, an amount defined as equal to three cups of coffee a day, and may cause problems with the heart rhythm of the fetus.

The Problem: Available Products Do Not Enable Self Management

Research showing dramatic Caffeine load differences:

“Specialty coffee's caffeine content varies capriciously” (www.ascribe.org). Scientists at the University of Florida College of Medicine recently analyzed 16-ounce servings of caffeinated coffee from specialty shops and found almost twice as much caffeine in the strongest brew—Starbucks regular, at 259 mg—compared with the weakest, Dunkin' Donuts regular, at 143 mg.

Another type of Starbucks caffeinated coffee purchased for several consecutive days varied even from 259 to 564 mg, almost as much caffeine as three maximum strength No-Doz.

The espressos range in size from 40 to 170 ml and contained 58 to 185 mg of caffeine.

Seven decaffeinated coffees from a sampling of shops were all found to contain some caffeine, though less than 18 milligrams per 16-ounce serving. The U.S. Food and Drug Administration currently does not require decaffeinated coffee to be absolutely caffeine-free. There are many variables that contribute to caffeine content from cup to cup, e.g., the type of bean, roasting and brewing methods and grind.

1) Natural widely varied concentrations: Caffeine concentration varies capriciously, and it is impossible to know how much caffeine is contained in products and servings.

1b) Natural coffee trees varieties are significantly different in caffeine content. That is why “Half and Half,” making 50% coffee, is not accurate information about absolute caffeine amounts. Table 1 below on page 11 shows caffeine content of coffees for various types and countries (www.Retailcoffee.com).

2) Man-made variations:
Coffee varies considerably in caffeine content per serving, ranging from 75-250 mg. Generally, dark-roast coffee has less caffeine than lighter-roast, because the roasting process reduces caffeine content of the bean.
Caffeine information is generally not available: Although products' information has increasingly become a major consumer issue, there is not yet an effective information system for caffeine content of products. The attitude of the industry to varied caffeine content due to being ‘natural biological material’ is that: “coffee-drinkers may have to live with caffeine variability.
No requirement for labeling of added caffeine amounts: When caffeine is added to foods or beverages in the United States, it must appear in the ingredients list on the label. But manufacturers aren't required to list the amount of caffeine added.
Warning for soft drinks?: In the European Union, a warning must be placed on packaging if the caffeine content exceeds 150 mg per litre. This includes caffeine from any source (including guarana, often found in energy drinks). In many countries, caffeine is classified as a flavouring.
Reducing the amount of coffee doesn't give real control: In order to learn about our sensitivity one needs an accurate measurement of caffeine content. People are advised to reduce caffeine content by variety of measures. One suggestion is to mix Half n' Half Decaffeinated with regular coffee, and/or regular with coffee substitute. This is an inexact approach due to the variety of innate caffeine contents and the specific extracting process being used (www.ext.colostate.edu).
Neither do good coffee habits prevent caffeine mistakes: Caffeine withdrawal is a typically unexpected result of misinformation (http://my.webmd.com), as one is not informed about absolute amounts of caffeine and can fail to avoid the necessity of withdrawal in spite of perceived good self-management.
People differ in their sensitivity and risks: Unexpected changes in caffeine content may lead to ‘False caffeine withdrawal’ symptoms, i.e., individual variations result in different thresholds. Thus accurate information is needed. Caffeine can enhance human performance by increasing alertness and speeding reaction time, but it can also cause increased heart rate, blood pressure and anxiety, according to previous research cited in a University of Florida study. Some phenomena may be even dangerous. This is so because people are not informed about shifts in caffeine content in the same product and place (http://my.webmd.com).

Thus, there is a need for a systematic method of labeling of available caffeine products and a standardized measure of caffeine consumption to enable problem reduction and benefit enhancement for safe, enjoyable caffeine consumption.

### REFERENCES

Weinberg, B A; Bealer, B K, The world of caffeine, New York & London: Routledge, 2001, ISBN 0-415-92722-B
Beaumont M, Batejat D, Coste O, Doireau P, Chauffard F, Enslen M, Lagarde D, Pierard C. Recovery after prolonged sleep deprivation: residual effects of slow-release caffeine on recovery sleep, sleepiness and cognitive functions. Neuropsychobiology. 2005; 51 (1):16-27.
Christopher G, Sutherland D, Smith A. Effects of caffeine in non-withdrawn volunteers. Hum Psychopharmacol. 2005; 20 (1):47-53.
Haskell CF, Kennedy D O, Wesnes K A, Scholey A B. Cognitive and mood improvements of caffeine in habitual consumers and habitual non-consumers of caffeine. Psychopharmacology (Berl). 2005; 179 (4):813-25.
Rogers P J, Heatherley S V, Hayward R C, Seers H E, Hill J, Kane M. Effects of caffeine and caffeine withdrawal on mood and cognitive performance degraded by sleep restriction. Psychopharmacology (Berl). 2005; 179 (4):742-52.
Varani K, Portaluppi F, Merighi S, Ongini E, Belardinelli L, Borea P A. Caffeine alters A2A adenosine receptors and their function in human platelets. Circulation. 1999; 99 (19):2499-502.
Wyatt J K, Cajochen C, Ritz-De Cecco A, Czeisler C A, Dijk D J. Low-dose repeated caffeine administration for circadian-phase-dependent performance degradation during extended wakefulness. Sleep. 2004; 27 (3):374-81.

### SUMMARY OF THE INVENTION

Accordingly, it is a principal object of the present invention to provide a standardized measure of caffeine consumption to enable problem reduction and benefit enhancement for safe, enjoyable caffeine consumption

It is one other principal object of the present invention to provide a systematic method of labeling of available caffeine products and caffeine consumption to enable caffeine control, problem reduction and benefit enhancement for caffeine consumption.

It is a further principal object of the present invention to provide effective content labeling for caffeine products, especially those caffeine products prepared to have a specified caffeine content.

It is another principal object of the present invention to provide caffeine labeling of existing and/or predetermined content, as per available serving devices and/or packages and/or newly-designed devices and packages.

As an example, for one cup of instant coffee that is prepared by putting in one teaspoon of granulated coffee may contain between 25 mg and 200 mg of caffeine. Such a range of concentrations, if properly labeled, could help one systematically control his daily caffeine consumption.

E.g., 100 mg is defined herein as “regular” caffeine content of a regular coffee cup equals 100%. This is because according to the average available concentration a regular cup contains 100 mg of caffeine. Correspondingly, 25 mg/teaspoon (tsp) making a cup of coffee will be defined as “25% caffeine coffee.” This means the same content by volume of coffee is 1 cup, but is pre-determined to contain only 25 mg, which is 25% of the regular 100 mg/cup=100% caffeine coffee. Other concentrations are determined similarly.

Decaffeinated (instant) coffee is herein defined as having 0-20 mg per regular 4-5 gram teaspoon of coffee powder that is used for preparation of one regular cup of coffee. Light-caff is defined as 20-50 mg caffeine/tsp/cup. Medium-caff is defined as 50-80 mg caffeine/tsp/cup. Regular-caff is defined as 80-120 mg caffeine/tsp/cup of coffee. High-caff or fast-caff is defined as 120-150 mg caffeine/tsp/cup. Supra-high or supra-fast or supra strong/strength coffee will be defined as 150-200 mg caffeine/tsp/cup.

The labeling can be limited to the exact concentration of caffeine mg/tsp/cup. E.g., 25% caffeine coffee and/or 25 mg caffeine/tsp/cup can be considered alone or can be combined with the caffeine category. I.e., ‘light coffee’—25-50 mg%/tsp/cup, or in the same category—‘light caff-coffee’ of 45%. Thus, this refers to a brand that contains 45 mg caffeine per tsp or per cup. The same applies to other categories, i.e., the label can contain either of type of information: 70% caff-coffee or medium-caff coffee or both forms of information, i.e. medium-caff coffee/70% caff-coffee which contains 70 mg caffeine/tsp/cup.

A caffeine reference unit is defined, which is based on the amount of caffeine in an average cup and/or tsp. of coffee-powder. Classifications of caffeine containing products are introduced: i.e. “Categories” of “regular,” higher and/or lower caffeine contents under the definition, i.e., of “regular,” “slow coffee” or “light” and/or “Fast-coffee,” “strong” and/or “heavy,” etc., respectively.

According to the principles of the present invention, a system of controlled caffeine-products is provided, based on ways of preparation, packaging, labeling and classifying, which enables self-monitoring and management of caffeine intake. The requirements are made according to individual needs and sensitivities, specific situations and/or daily adequate intake, i.e. for sleep-awakening management, for preventing headaches and blood pressure shifts, for sport and diet planning, for management of children, mothers, nursing and pregnant women and sensitive people, etc. This system helps in utilizing caffeine to better serve personal needs, health and well being, thereby being remedial to uncontrolled, potentially harmful consumption.

### Caffeine Management:

Caffeine Management Strategies: Coffee, tea and other caffeine-containing beverages are tools to be managed. One preferably should not drink more than is needed. Better to slow the rate of caffeine drinking by spreading it out, and when one does not need to be wakeful, to stop drinking it. One can also ‘fast’ the rates, when acutely needed. One needs to control the anti-sleep stimulants to keep both fully awake, and still allow for adequate sleep time. Thus, caffeine management may be a significant contributor to well being.

High-frequency, low-dose caffeine for longer awakening: Caffeine is best administered in a larger number of smaller doses/day, with the doses coming later in the day. Morning “big gulp,” coffee drinkers may misuse the power of caffeine, whereas people who take small amounts of caffeine regularly during the day may be able to avoid falling asleep and perform well on cognitive tests without affecting their nighttime sleep.

Subjects consuming a low-dosage of caffeine, 0.3 mg/kg/hr, performed better on cognitive tests and exhibited 5 times fewer accidental sleep onsets, or micro-sleeps for the placebo vs. caffeine receiving subjects. Despite their enhanced wakefulness, the caffeine-taking subjects reported feeling sleepier than their placebo counterparts, suggesting that the wake-promoting effects of caffeine do not replace the restorative effects gained through sleep and that they were effective in countering the detrimental performance effects of extended wakefulness. This accords well with the hypothesis of adenosine as mediator of performance decrements associated with extended wakefulness and may lead to new strategies to use caffeine against neurobehavioral response to sleep loss (Wyatt, et al., 2004).

Twice/day Slow-Release Caffeine (SRC): This was found effective to maintain vigilance and performance during sleep deprivation. SRC appears to have no unwanted side-effects on the work schedule (Beaumont, et al., 2005).

WHAT IS AVAILABLE IN THE MARKET: One who wants to control and monitor his caffeine intake has the following products available, though they do not provide for an accurate personal caffeine program:

Decaffeinated coffee: “Decaff” is usually not accepted as high taste coffee, whereas caffeine is strongly associated with good taste and rewards from coffee. Thus, the consumption of this kind of coffee is quite restricted in benefits.

Low caffeine products: As described above, due to individual variations and the risks associated with over-dosing caffeine, there is an increased need for lower caffeine doses.

Half n' Half coffee: Recently, there have been recommendations for in-house use of blended coffee, by self-mixing regular caffeine coffee and decaffeinated coffee. Also there are already pre-prepared mixes of Half n' Half, e.g., Half caffeine Mexican blend, a blend of decaff beans and regular beans. Decaff beans are Swiss water processed and the product is organically grown (see Website: worldwide impact: (www.coffee-tea-etc.com)).

Half soy half coffee: Rocamojo offers a blended coffee, so consumers do not have to give up caffeine and can enjoy the half coffee, half soy alternative beverage. Drink hot or sprinkled on top of ice cream (see www.ricanihi.com).

Half caff—half decaff skinny latte: This is another lowered caffeine product (see specialty-coffee.com).

Low caffeine, genetically modified (GM) coffee tree: GM coffee beans lack the key caffeine-making gene. They produce up to 70% less of the stimulant than normal plants, bringing their levels in line with chemically decaffeinated beans (Hiroshi Sano from the Nara Institute of Science and Tech, Japan).

Low caffeine, Arabica cultivar, selected during development stages: Selection is by a screening process for a few pre-indicates of the future low caffeine plant and coffee-beans (see U.S. Pat. No. 5,436,395, “Low Caffeine,” 1994, details above in “background”).

### EXAMPLE 1

“Slow-coffee” and/or “light-coffee” and/or “low-caffeine” products between 20-50 mg/tsp/cup, for application of the strategy of high frequency, low caffeine-dose coffee drinking. This is for people who want better individual and ad-hoc management of the coffee during the day, on a regular basis, for improving functions and prevention of sleeping episodes and problems and/or headaches, etc. For example, a cup of 25% coffee=25 mg caffeine/tsp/cup, (12 cups/day=an adequate daily allowance), i.e., every hour; 50%=50 mg caffeine/tsp/cup, (6 cups/day), i.e., coffee every 2 hours.

### EXAMPLE 2

Acceptable intake of medium caffeine coffee comprising 75 mg/tsp/cup or 4 cups/day=acceptable intake, i.e., 1 cup every 3 hours.

### EXAMPLE 3

“Fast coffee” products having 125%/mg or 150%/mg and/or 200%/mg caffeine/tsp/cup taken afternoon and/or before exams, late night, long driving night work, before sport, etc. This is for people who need high caffeine dosage, i.e., stronger coffee, for a specific reason and situation.

### EXAMPLE 4

Presentation of the Caffeine Related Units is shown in FIG. 2 described below.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 is a schematic representation of the definition of recommended daily intake of 300 mg, in accordance with the principles of the present invention;

FIG. 2 is schematic representation of the 100% and 150% caffeine products, in accordance with the principles of the present invention;

FIG. 3 is schematic representation of the 30% light-caffeine coffee, used in accordance with the principles of the present invention;

FIG. 4 is a bar graph illustration of the caffeine consumption in mg for strengths per cup and numbers of cups of coffee, in accordance with the principles of the present invention;

FIG. 5 is schematic representation of various caffeine bars, in accordance with the principles of the present invention; and

FIG. 6 is schematic 75% medium caff coffee, in accordance with the principles of the present invention.

### DETAILED DESCRIPTION OF AN EXEMPLARY EMBODIMENT

The principles and operation of a method and a system according to the present invention may be better understood with reference to the drawings and the accompanying description, it being understood that these drawings are given for illustrative purposes only and are not meant to be limiting.

Table 1 below shows the range of caffeine concentration in various coffee sources. This emphasizes the problem of a “50% coffee” mix, which does not promise any caffeine references. E.g., it can be 50% 101 (Mocha Mattari (Yemen)) strength or 50% 142 (Tanzania Peaberry) strength, having about 40% difference in caffeine content between the two, although people were looking for 50% reduced caffeine strength, but may be getting 50% of strong coffee, which may be much more than they want and calculate.

Table 2 below shows that the most popular coffee contains, on average, 100 mg/coffee serving. As the regular way of preparing coffee is using 1 teaspoon (tsp), the ‘standard’, ‘regular’, ‘normal’, ‘100%’ coffee is here defined as the reference measure/unit/serving taken as 100% caffeine coffee.

Caffeine mg and % are here shown also as ‘caffecents’ (cent as 1/100 of a unit, or caffecents as 1/100 parts of a coffee cup) is equal to the caffeine in one cup, according to the definition of 100 mg=100%=1 regular cup and 1 regular tsp.

‘Daily caffeine %’ or ‘daily caffecents %’ are defined as % of daily acceptable intake (now defined as 300 mg/day), i.e. 1 cup of 100% caffeine coffee (100 mg caffeine) is 33% of the daily acceptable intake. Acceptable is defined as a threshold just short of too much, i.e., an amount eliciting the onset of undesirable symptoms.

Teas and soft drinks and/or other ‘caffeine containing products’ having lower caffeine content can be also compared to coffee products or related to their naturally or predetermined lower levels. E.g., a 1 g tea-bag of black tea that provides 70 mg caffeine, can be related to coffee caffeine content by defining it as “70% caffeine tea” (70 mg/1 g tea-bag/1 cup). This can also be related to the “usually lower levels of caffeine concentration products,” such as soft drinks. Thus, ‘high caffeine tea,’ i.e. 70% caffeine tea (70 mg/tsp/cup) has higher than average tea-caffeine levels, 50% (50 mg/tsp/cup) on average.

Cocoa products usually have low caffeine content, between 6-35 mg/serving. They need to be defined more subtly, as it is not the major purpose of the product. Thus, milk chocolate, which is usually served for children, can be defined as “de-caff” or ‘ultra-lite caffeine milk chocolate’, 8% caffeine (8 mg/serving).

Table 1 is a listing of coffees of various brands and origins, as is known in the prior art.

| Coffee Bean type | Caffeine Content % |
|---|---|
| Brazil Bourbons | 1.20 |
| Celebes Kalossi | 1.22 |
| Colombia Excelso | 1.37 |
| Colombia Supremo | 1.37 |
| Ethiopian Harrar | 1.13 |
| Guatemala Antigua | 1.32 |
| Indian Mysore | 1.37 |
| Jamaican Blue Mountain | 1.24 |
| Kenya AA | 1.36 |
| Kona Extra Prime | 1.32 |
| Mexico Pluma Altura (High Grown) | 1.17 |
| Mocha Mattari (Yemen) | 1.01 (lowest) |
| New Guinea | 1.30 |
| Panama Organic | 1.34 |
| Sumatra Mandheling | 1.30 |
| Tanzania Peaberry | 1.42 (highest) |
| Zimbabwe | 1.10 |

Table 2 is a listing of the caffeine content of various products and beverages, as constructed in accordance with the principles of the present invention.

| | | | Serving | | % of Daily- | Caffeine-Cents |
|---|---|---|---|---|---|---|
| | | Caffeine | Volume | | Caffeine | (% of cup & mg |
| The Product | | (mg)/serving | (ml) | | intake | Caffeine) |
| Coffee | drip brewed | 100 | 1 | tsp/1 cup | 33.0 | 100 |
| | Percolated | 120 | 1 | tsp/1 cup | 40.0 | 120 |
| | Instant | 90 | 1 | tsp/1 cup | 30.0 | 90 |
| | brewed decaf | 5 | 1 | tsp/1 cup | 1.5 | 5 |
| | instant decaf | 3 | 1 | tsp/1 cup | 1.0 | 3 |
| | | | | | 0.0 | |
| Tea | Green | 35 | 1 | tbag/1 cup | 11.7 | 35 |
| | Black | 70 | 1 | tbag/1 cup | 23.3 | 70 |
| | canned iced tea | 35 | 1 | tbag/1 cup | 11.7 | 35 |
| | | | | | 0.0 | |
| Soft Drinks | leading colas* | 45 | 1 | can+ | 15.0 | 45 |
| | (diet &reg.) | | | | | |
| | mountain dew | 54 | 1 | can | 18.0 | 54 |
| | josta (pepsico) | 58 | 1 | can | 19.3 | 58 |
| | surge (coca cola) | 51 | 1 | can | 17.0 | 51 |
| | jolt cola | 72 | 1 | can | 24.0 | 72 |
| | | | | | 0.0 | |
| Cocoa | cocoa beverages | 13 | 1 | cup | 4.3 | 13 |
| | | | | | 0.0 | |
| Chocolate | milk chocolate** | 6 | 29.5 | g | 0.0 | 6 |
| | baking chocolate | 35 | 29.5 | g | 11.7 | 35 |
| | small candy bar | 25 | | | 8.0 | 25 |

*Calculated per 1 tea-spoon (tsp) and/or 1 coffe-bag and/or 5-8 ounce/150-250 ml standard cup that contains an average of about 100 mg caffeine.
**gram(weight).
+360 ml

Table 2a is a listing of the caffeine content of various beverages and other substances, used in accordance with the principles of the present invention.

| | | | % of Daily | Caffeine |
|---|---|---|---|---|
| | | Serving | caffeine | content |
| product | Caffeine(mg) | volume (ml) | intake | (% & mg) |
| Black tea | 70 | 1 cup | 23.3 | 70 |
| Drip brewed | 100 | 1 cup | 33.0 | 100 |
| coffee | | | | |
| Coca cola | 51 | 1 can | 17.0 | 51 |
| can | | | | |
| Small candy | 25 | | 8.0 | 25 |
| bar | | | | |
| Percolated | 120 | 1 cup | 40.0 | 120 |
| coffee | | | | |
| Green tea | 35 | 1 cup | 11.7 | 35 |

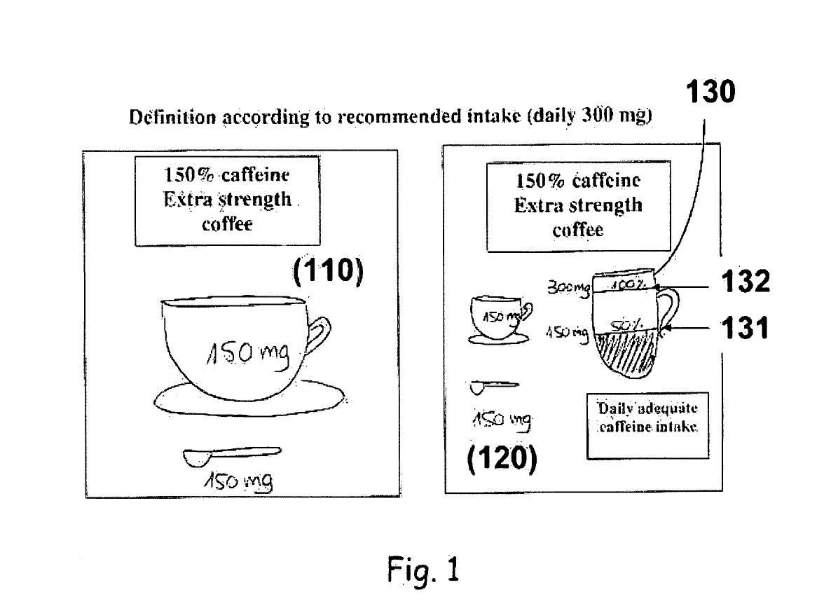

FIG. 1 is a schematic representation of the definition of recommended (acceptable) daily intake of 300 mg, in accordance with the principles of the present invention. A cup and a teaspoon pair of 150% extra strength coffee 110 is shown on the left. On the right a cup and a teaspoon pair representing 150% extra strength coffee is shown again, along with a larger cup 130 showing the portion of the daily acceptable caffeine intake. Larger cup 130 shows the 100% acceptable daily intake of 300 mg for the full level 132 and 50% of the acceptable amount at 150 mg for the half-full level 131.

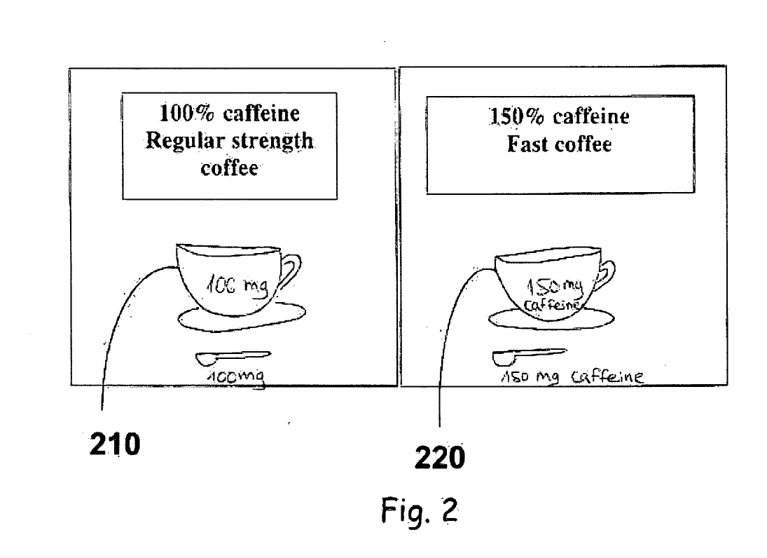

FIG. 2 is schematic representation of 100% and 150% caffeine products, in accordance with the principles of the present invention. The absolute amount in mg is shown for each cup and teaspoon pair, 100 mg 210 and 150 mg 220 are shown.

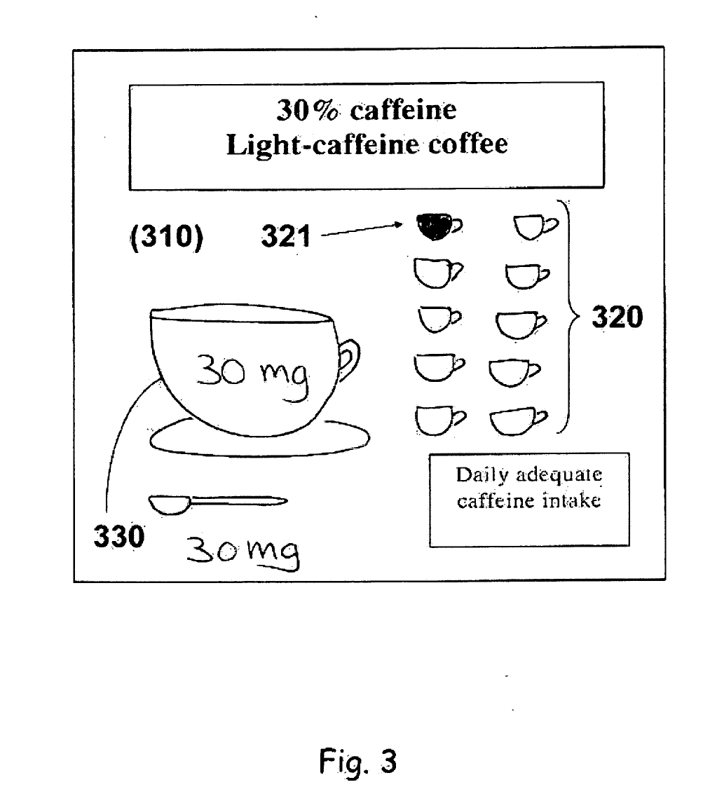

FIG. 3 is schematic representation of 30% light-caffeine coffee 310, used in accordance with the principles of the present invention. One cup of the 10 cups of light-caffeine coffee 320 is shown as black 321, representing a 30 mg cup 330, which is 1/10 of the daily acceptable caffeine intake.

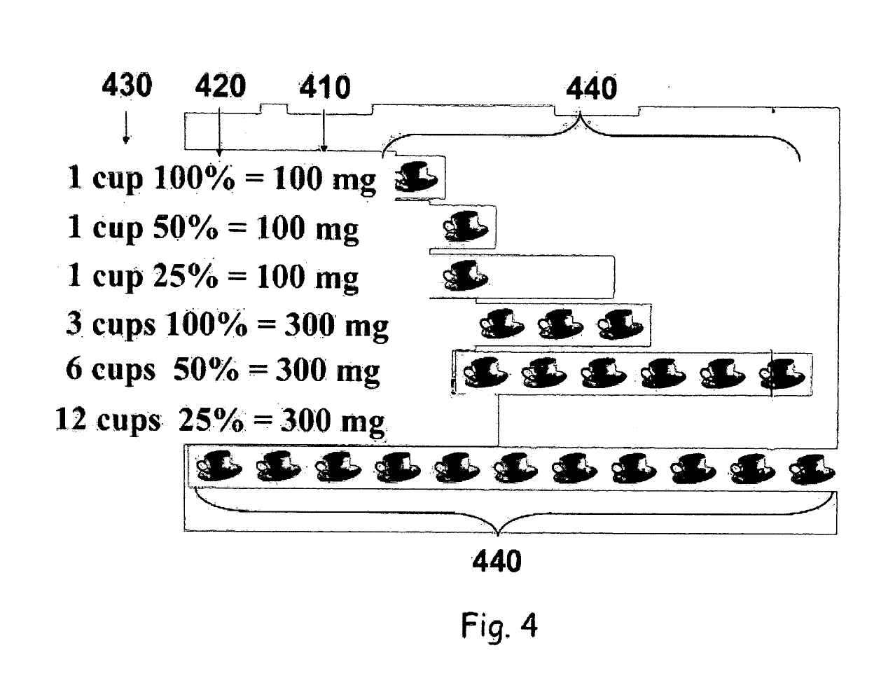

FIG. 4 is a bar graph illustration of caffeine consumption in mg for strengths per cup and numbers of cups of coffee, in accordance with the principles of the present invention. Caffeine consumption is shown in mg 410 for strengths per cup in percent 420 and numbers of cups of coffee in numbers 430 and graphical bars 440.

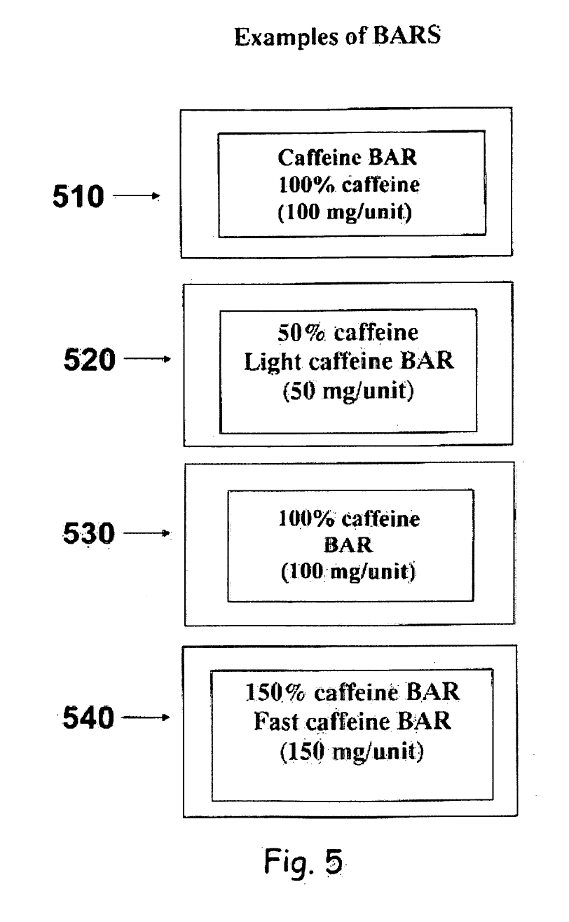

FIG. 5 is a schematic representation of various caffeine bars, in accordance with the principles of the present invention. The 100% caffeine bar is shown in 2 representations 510 and 530. Also shown are a 50% caffeine bar 520 and a 150% caffeine bar 540.

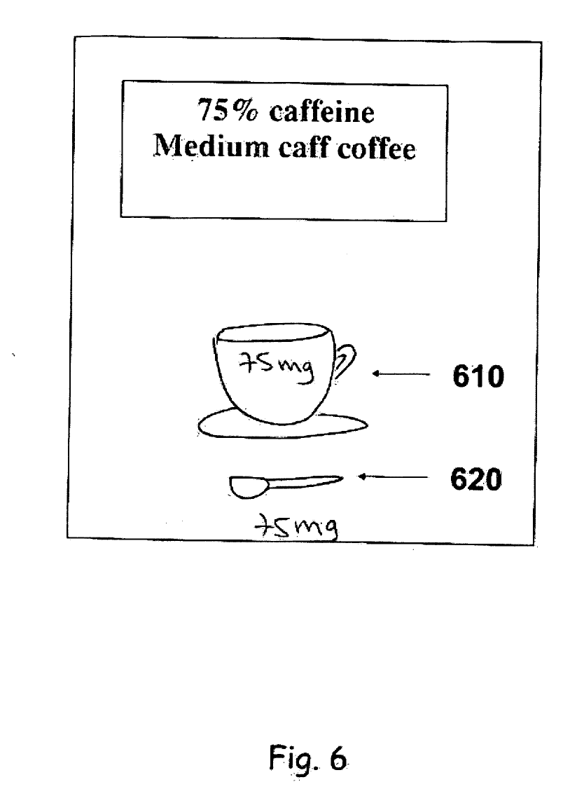

FIG. 6 is schematic 75% medium caff coffee, in accordance with the principles of the present invention. A cup 610 and a teaspoon 620 pair of 75% medium caff coffee is shown.

It is to be understood that the phraseology and terminology employed herein are for the purpose of description, and should not be regarded as limiting.

It is important, therefore, that the scope of the invention is not construed as being limited by the illustrative embodiments set forth herein. Other variations are possible within the scope of the present invention as defined in the appended claims and their equivalents.

I claim:

1. A caffeine management system, comprising caffeine products comprising at least one of natural and pre-determined caffeine content, preparation means thereof, at least one of labeling existing and predetermined contents in at least one of absolute and relative caffeine consumption-units, as per acceptable servings/packaging, and at least one of available devices and newly-designed devices and packages.

2. The caffeine management system of claim 1, wherein said caffeine products are prepared by combining caffeine sources comprising at least one of differing caffeine contents, wherein said differing caffeine contents are due to at least one of inherent genetic nature and caffeine processing.

3. The caffeine control/management system of claim 1, wherein a caffeine reference consumption unit/measure is defined as one regular cup of coffee comprising 100 mg caffeine.

4. The caffeine management system of claim 1, wherein one of said caffeine products comprises coffee powder, having the caffeine equivalent of one (1) cup of coffee at 100 mg in one (1) teaspoon (tsp) of said coffee powder.

5. The caffeine management system of claim 3, wherein said caffeine reference unit of 100 mg is pre-determined to be:
the content of at least one of a ‘regular coffee’-powder teaspoon (tsp);
one of tsp equivalent available devices; and
at least one of a specially designed spoon-dose/portion and packaging, wherein said caffeine reference unit comprises at least one of one coffee-cup equivalent (100 mg) of a “coffee-bag”, a coffee pouch, a “caffeine-dose” bottle and a predetermined caffeine dose.

6. The caffeine management system of claim 1, wherein said caffeine products are labeled and categorized according to a 100% reference coffee cup/serving, and wherein a “fast-coffee” energy bar comprises more than 100 mg caffeine also referred to as a 100% reference consumption coffee-dose, and wherein at least one of a “slow-coffee,” “light-caffeine” and a “slow-caffeine” energy bar comprises less than 100 mg also referred to as 100% reference consumption coffee-dose, and wherein a “fast caffeine bar” comprises between 120% and 150% mg caffeine per portion, and wherein said portion between 120% and 150% is defined as having between 120 and 150 independent caffeine units.

7. The caffeine management system of claim 1, further comprising information about content and use of “de-caffeinated” products comprising at least one of coffees, teas and colas.

8. The caffeine management system of claim 1, further comprising at least one of:
means for implementing information about content and use of caffeine sources;
means for implementing information across botanical and processing methods; and
means of use for personal monitoring and control of consumption according to individual requirements and plans.

9. The caffeine management system of claim 1, wherein said caffeine content can be graphically depicted by at least one of icons, drawings and graphs.

10. The caffeine management system of claim 9, wherein said graphs describe at least one of the physiological effect and the kinetics of caffeine as opposed to the circadian rhythm, hunger for sleep and sleep-awakening patterns.

11. The caffeine management system of claim 1, wherein caffeine content may be defined by the physiological effect of said caffeine content.

12. The caffeine management system of claim 6, wherein said at least one of a “slow-coffee,” “light-caffeine,” “slow-caffeine” and “low-caffeine” reference consumption coffee-dose can be attained by combinations of a “slow-release” coffee, by means of encapsulation together with at least one of low concentration and decaffeinated coffee that combine to provide said at least one of “slow-caffeine” and “light-caffeine” planning.

13. The caffeine management system of claim 6, wherein the definition of said relative caffeine content information/labeling is categorized by the relative concentrations and physiological impact.

14. The caffeine management system of claim 6, wherein the categories of “fast-coffee,” “strong coffee,” and “extra strong coffee” include the caffeine products having above 100-mg/tsp/cup that will be used for applying the “strong coffee” and “fast coffee”/fast caffeine plan.

15. The caffeine management system of claim 14, wherein said “fast coffee”/“strong coffee”/“extra strong coffee” plan is further supported by caffeine supplements, taken with, added to caffeine foods and drinks, to attain the exact amount and for accurate use in time schedules.

16. A method for labeling and packaging based on at least one of absolute content and relative caffeine consumption units, wherein 1 mg=1% caffeine is defined as at least one of 1 “caffeine 1%” , “caffe-cent,” 1 “cup-cent” and 1 “centi-caffes,” and wherein a caffeine reference consumption unit/measure is defined as one regular cup of coffee comprising 100 mg caffeine.

17. The method of claim 16, wherein a caffeine containing products' low reference unit is defined as 50 mg/serving, and wherein the application of at least one of the terms “slow,” “light,” “regular,” “strong” and “fast” caffeine products is based on relative content compared to said 100 mg caffeine reference unit.

18. The method of claim 16, wherein said method is based on the caffeine content in reference to daily adequate intake defined as 300 mg/day, wherein 1 coffee cup=100 mg caffeine contributes 33% of said adequate intake.

19. The method of claim 16, wherein predetermined and labeled caffeine products are used for caffeine control/management of the daily caffeine intake for prevention of sleep-awakening, prevention of head-aches and coffee-withdrawal syndrome in people who are sensitive to it in situations of at least one of pregnancy, nursing and for children.
